(19) United States
(12) Patent Application Publication
(10) Pub. No.: US 2024/0086502 A1
(43) Pub. Date: Mar. 14, 2024

(54) METHODS OF CONTROLLING PERMISSION ON A DEVICE

(71) Applicant: Arm Limited, Cambridge (GB)

(72) Inventors: Michael BARTLING, Austin, TX (US); Derek Del MILLER, Austin, TX (US); Mark Richard NUTTER, Austin, TX (US); Hugo John Martin VINCENT, Cambridge, Cambridgeshire (GB)

(21) Appl. No.: 17/943,428

(22) Filed: Sep. 13, 2022

(51) Int. Cl. G06F 21/31

(52) U.S. Cl. CPC G06F 21/31

(57) ABSTRACT

A computer-implemented method of operating a device is provided. The method comprises operating a sensor to capture a data input, individuating an element of the data input, tagging an individuated element with metadata, matching the metadata with an associated permission set, and applying a restricting function defined in the associated permission set to the individuated element during a process flow to produce augmented reality output data restricted as required by the associated permission set. A device is also provided, comprising a sensor, an individuating component to individuate an element of sensor data from the sensor, a tagging component to tag the individuated element, a matching component to match a tag of the individuated element with a permission of a permission set, and a restricting function component to restrict an application's interaction with the individuated element.

### BACKGROUND

The present techniques relate to controlling permissions on electronic devices. The methods may be useful for restricting, obscuring, obfuscating, and/or making more secure, or more private, data obtained from sensors of the devices. The devices may be augmented reality devices

Applications that run on electronic devices, such as mobile phones, tablets, and laptops, are given explicit permission to control, and/or to access/modify data from, sensors of the devices. Examples of such sensors include cameras, microphones, and location sensors.

Permissions requested by and/or granted to an application depend on the purpose and function of the application. For example: a maps application running on a mobile phone may request access to data from a location sensor of the phone; and a camera application may request permission to control the phone's camera sensor and to access and modify data therefrom.

This permission model can be referred to as “coarse-grained” in that the permissions provide indiscriminate access to the sensor and/or sensor data. For example: once granted permission to control the camera and access/modify camera data, the camera application's ability to control the camera and access/modify the data is total rather than dependent on the nature or content of the data.

### BRIEF DESCRIPTION OF THE DRAWINGS

The present techniques are diagrammatically illustrated, by way of example, in the accompanying drawings, in which:

FIG. 1 shows a flow chart illustrating steps of a method according to an embodiment; and

FIG. 2 shows a schematic representation of an apparatus according to an embodiment.

### DETAILED DESCRIPTION

According to a first technique there is provided a computer-implemented method of operating a device, comprising: operating a sensor to capture a data input; individuating an element of the data input; tagging an individuated element with metadata; matching the metadata with an associated permission set; and applying a restricting function defined in the associated permission set to the individuated element during a process flow to produce augmented reality output data restricted as required by the associated permission set.

According to a second technique there is provided a device, comprising: a sensor; an individuating component to individuate an element of sensor data from the sensor; a tagging component to tag the individuated element; a matching component to match a tag of the individuated element with a permission of a permission set; and a restricting function component to restrict an application's interaction with the individuated element.

Broadly speaking, embodiments of the present techniques provide for improved control over what permission an application has to control a device sensor, to view data from the device sensor, and/or modify data from the device sensor.

In an embodiment, an operating system of a device may individuate elements from sensor data and enforce permissions based on the individuated elements and/or metadata thereof.

In such embodiments, the device can implement a “fine-grained” permission model in which an application requesting access to the sensor data is provided access thereto according to an enforcement of the permissions against individuated elements of the sensor data. This improves the security and privacy of others in the environment in that the permission set enables the restriction/obfuscation of sensitive information and/or identifying details. For example: by identifying an individuated face, voice, car license plate, and the like; and restricting/obfuscating those individuated elements prior to releasing any sensor data or relinquishing any control over the sensor to the application, an application's ability to access such sensitive/identifying data is reduced or eliminated while other, less sensitive/identifying data is made available.

Where the word “individuate” and its derivatives are used herein, they are intended to encompass at the least the following meanings: classify according to, for example, semantically, by feature, by location in space and/or time, by data object type, and/or by application of one or more machine learning inference models; distinguish, such as by assigning one or more distinguishing tags, metadata, titles, and/or other data objects and/or by otherwise marking in an identifying manner; outline.

Where the word “obfuscate” and its derivates are used herein, they are intended to encompass at least the following meanings: to obscure; blur; hide; make difficult or impossible to see, hear, and/or understand; to remove so as to make difficult or impossible to see, hear, and/or understand; make unclear; make unintelligible; garble.

Where the word “application” and its derivatives are used herein, they are intended to encompass at least the following meanings: a software package or program, particularly one that performs a specific function such as for an end user of the device on which the package executes or for another software package or program; and/or a software package or program that is designed to carry out a function or task other than the one relating to the operating system of the device itself; and/or a plug-in, i.e., a software package or program that adds new functions and/or features to another software package or program.

In an embodiment, an application may request to modify individuated sensor data. In response, the operating may check a permission set and examine the content of the request. The content of the request may include an individuated element the application wishes to modify and a type of modification. The operating system may then determine whether to permit the application to perform the modification depending on the content of the request and on the permission set.

In such embodiments, the device can improve the safety of a user of the device in such cases where a modification of individuated sensor data is detrimental, such as when modification may endanger the user. For example: when capturing image data from a camera sensor for an augmented reality application, an individuated element may be the ground, and it would be potentially unsafe for the user if the application was permitted to modify image data relating to the ground to, say, obscure the ground and risk the user mis-stepping or tripping over an obscured object.

Not only are improved control, security, privacy, and safety achieved: improved user convenience is also provided by reducing or eliminating the need for a user to micromanage each application's individual permission requests. This may be particularly important when the device is an augmented reality device, i.e., when the device is capable of augmenting sensor data with modified and/or additional data and providing the augmented data to the user.

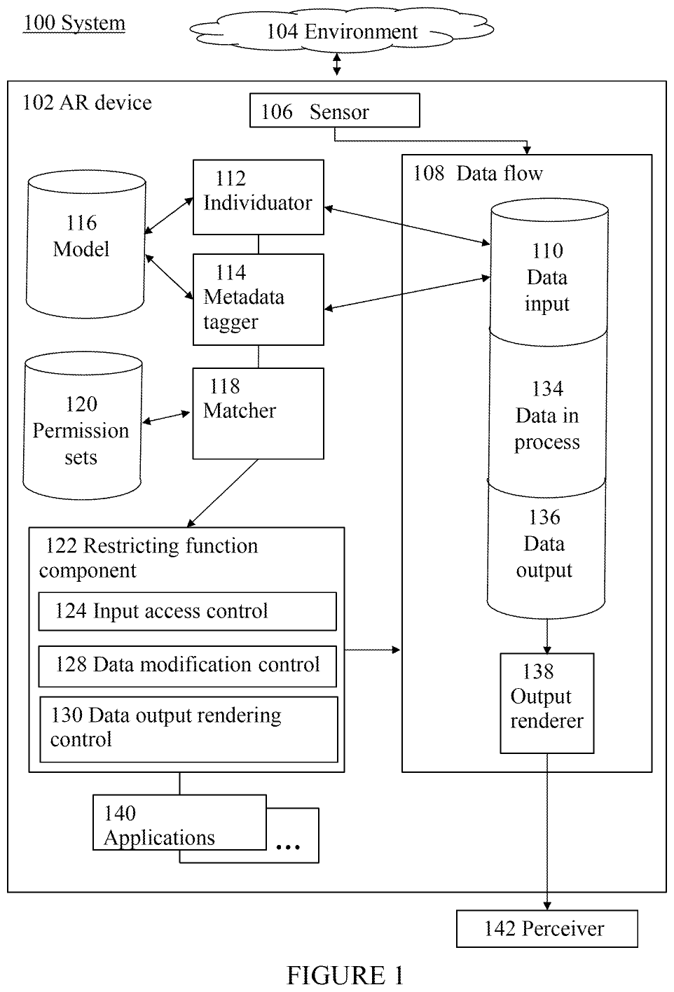

Referring to FIG. 1, a system (100) is shown comprising a device (102), which in an embodiment is an augmented reality device, in communication with an environment (104).

In an embodiment, the device (102) comprises one or more sensors (106) for gathering sensor data representing aspects of the environment (104). For instance, where a sensor (106) is a microphone, the sensor data includes audio data. In embodiments, the one or more sensors (106) may include one or more: cameras, microphones, locating devices, accelerometers, antennae, transceivers (such as radio, WiFi, Bluetooth, and near-field connectivity); magnetometers; light sensors; and fingerprint sensors. The one or more sensors may include one or more active sensors, such as depth sensors and LIDAR sensors (i.e., sensors that use light detection and ranging technology). Active sensors emit a signal into the environment and detect responses to the emitted signal, such as reflections.

A sensor may be a virtual sensor in that it is implemented in software: for example, having been passed audio data from a microphone or other audio sensor, a virtual audio sensor (in a software layer) senses “wake up” words present in the audio data; or, having been passed acceleration data from an accelerometer, a virtual linear accelerometer sensor (in a software layer) subtracts from the acceleration data an acceleration due to gravity to obtain linear acceleration.

A sensor may be a contextual sensor in that, in a software layer, the contextual sensor performs an inference based on sensor data to infer a particular context or activity being performed by a user of the device, for example: running, cycling, entering/exiting a vehicle, and/or entering/exiting an area (based, for example, on location/geofencing data).

In an embodiment, sensor data from the one or more sensors (106) enters a data flow (108) through which the sensor data passes before being provided to a perceiver (142), who may be a user of the device (102).

A first stage of the data flow (108) is designated data input (110), where the incoming sensor data comprises raw (i.e., unmodified) sensor data. Other stages are discussed later.

In an embodiment, the device (102) comprises an individuator (112), which may also be referred to as an individuating element. In an embodiment, the individuator (112) is implemented in an operating system (not shown) operating the device (102). The individuator is configured to receive raw sensor data from one or more sensors (106), such as via data flow (108), and to individuate elements of the raw sensor data.

In an embodiment, the individuation comprises the operating system applying an inference procedure to raw sensor data to identify individual elements recognizable within the raw sensor data. For example: where the raw sensor data comprises raw image data, an image classification inference procedure may be selected by the operating system and applied to the raw sensor data to identify which portions of the raw sensor data correspond to different objects and/or objects of distinct types.

In an embodiment, the device (102) comprises a metadata tagger (114), which may also be referred to as a metadata tagging component. In an embodiment, the metadata tagger (114) is implemented in the operating system (not shown) operating the device (102).

In an embodiment, raw sensor data is passed from the data flow (108) to the individuator (112) and the metadata tagger (114). The individuator (112) analyses the raw sensor data and individuates elements identified by the analysis. The metadata tagger (114) tags each individuated element with metadata classifying and/or otherwise identifying those elements. For example: the individuator (112) is passed image data from a camera sensor. The individuator (112) identifies and distinguishes recognizable entities from other elements and background in the raw sensor data, the entities comprising, for example, a person's face, a car, a tree, a pavement, and a building. For example, in the case of an individuated element being a person's face, the metadata tagger (114) tags the portion of the image data corresponding to the person's face with metadata classifying that portion as a person's face, the portion corresponding to the car as a car, and so on.

In an embodiment, the metadata tagger (114) tags one or more individuated elements with further classifying information, such as state information (the car may be tagged with metadata identifying the car as “moving” or “stationary”, for example) and/or more fine-grained information (the person's face may be tagged with metadata identifying the person as “a child” or “an adult”, for example).

In an embodiment, the individuator (112) and metadata tagger (114) are operable in conjunction with a model (116) to individuate and tag the individuated elements. The model (116) may be a model trained on an appropriately large data set of image elements that have been tagged with identifying metadata. In one example, such a model may have been trained using expert systems techniques to extract expert knowledge from a human provider of input data and store it in the form of, for example, a deterministic decision tree structure leading to a recognition of an image element. In another example, a model may have been developed using neural network techniques trained on a prepared and tagged dataset to provide a recognition of an image element based on the neural network's estimate of the probabilities that an element is identifiable as, for example, a person's face or a car. In an even more fine-grained implementation, the model may be trained to individuate, for example, named individual persons or other specific individual objects that may be imaged, so that controls according to the present technology may be placed on application activities for those individual entities.

In an embodiment, the device (102) comprises a matcher (118), which may also be referred to as a matching component. In an embodiment, the matcher (118) is implemented in the operating system (not shown) operating the device (102).

In an embodiment, the device (102) comprises one or more permission sets (120). In an embodiment, one or more permission sets may be stored externally to the device and accessible from the matcher (118) of the device (102) by, for example, wired and/or wireless connection to the storage element (not shown). The storage element may be part of a server (not shown) and accessible to the matcher (118) of the device (102) via an Internet connection.

In an embodiment, each permission set comprises a data structure which associates permission data with each type of classification and/or identification defined by the metadata applied to individuated elements by the metadata tagger (114) and with one or more applications (140) installed on, installable on, or executable on the device (102). The permission data defines whether, and to what extent, a given application is permitted to view, listen to, access, control, modify, or otherwise interact with an individuated element of sensor data of a given sensor. For example: the permission data may permit applications (140) to access all image data from a camera sensor except any portion of any image corresponding to a child's face; and the permission data may permit an image editing application to access any portion of any image and permit editing of any portion except any corresponding to any person's face or any identified text in the image.

In an embodiment, the device (102) comprises a restricting function component (122) configured to restrict certain applications' access to, control of, modification of, and/or other interaction with certain individuated elements, in accordance with one or more permission sets (120). In an embodiment, the restricting function component (122) is implemented in the operating system (not shown) operating the device (102). Restricting function component (122) may be operable to perform its control functions between applications (140) and data flow (108).

Restricting functions may take various forms, may be applied at various stages of the data flow (108), and may be applied in response to requests from applications and depending on the content and/or nature of those requests. Restricting functions may include security functions, privacy protection functions, access security functions, modification restriction functions, and obfuscation functions.

In an embodiment, the restricting function component (122) comprises an input access control component (124) operable to apply access controls when an application (140) requests access to data for an individuated element. In one example, if an application does not have a level of security adequate to be allowed to access the data, the restricting function component is operable to refuse to allow access. In this way, insecure applications, such as social media apps, may be prevented from accessing data that may reveal, for example, a car registration in conjunction with a driver's face or a uniformed person's face in conjunction with a name badge, without specific authorization.

In an embodiment, the restricting function component (122) comprises a data modification control component (126). Data modification control component (126) is operable to control whether an application (140) is permitted to modify data for an individuated element. For example, using data modification control component (126), an application (140) may be prevented from applying a distortion to a person's face, or from marking out a face element for copying to another application, or from superimposing a potentially misleading or dangerous overlay on an individuated element of a scene.

In an embodiment, the restricting function component (122) comprises a data output rendering control component (130). Data output rendering control component (130) is operable to control what an application (140) is permitted to cause to be rendered by output renderer (138) as output. For example, when an individuated element of a scene is tagged as a child's face, an application may be restricted from rendering that child's face in an output image. In a related example, where an individuated element of a scene is tagged as a person's face and there is associated data relating to, for example, a detection of a mobile phone identifier associated with that person, the application may be prevented by the present technology from displaying the mobile phone identifier as an image annotation.

In a further example, consider an assistive application that can modify colors of objects in a scene for the benefit of a person with a color vision deficiency. It may be safety critical to ensure that, for example, street signs are only modified in such a way that the message they convey is not obscured by any modification. In this example, the color contrast between the background of the sign and any text or symbols displayed on the background must be maintained for safety reasons. Applying the present technology permits only those modifications to the rendered output that are consistent with the correct functioning of the sign in conveying its information to the user.

While the above examples refer to visual and audio data, the present technology extends to other emissions capturable from the environment (104), such as electromagnetic emissions, including Bluetooth™ MAC addresses and similar. The term “electromagnetic emissions” is intended to include any responses and/or reflections of signals originally emitted from the device, such as when the device is using a LIDAR sensor.

In an embodiment, a first stage of the data flow (108) is a data input stage (134), where raw sensor data is held available to be analyzed by individuator (112) and metadata tagger (114).

In an embodiment, a second stage of the data flow (108) is a data in process stage (134), and it is to data at this stage that input access control (124) and data modification control (128) apply to control what access and what permission to modify the data for any individuated element is granted to an application (140).

In an embodiment, a third stage of the data flow (108) is a data output stage (136) and it is to data at this stage that data output rendering control (130) applies to control what data for any individuated element the output renderer (138) is permitted to render on behalf of an application (140). The application (140) may be an untrusted application.

In an embodiment, the device (102) comprises an output renderer (138). The output renderer (138) is configured to render output data which comprises raw sensor data having been individuated, analyzed, tagged, and restricted according to a matching between the individuated elements and the content of one or more permission sets, as described above. For example: the output renderer may render image data comprising an environmental scene including a child whose face is obfuscated/blurred by application of a restriction function (such as a privacy protection function and/or, where a car is visible but the registration/license plate is censored, and where all other objects of the scene are visible as would be expected from a photograph taken with a camera.

In an embodiment, the output renderer (138) is configured to output rendered output data to a perceiver (142) or user of the device (102).

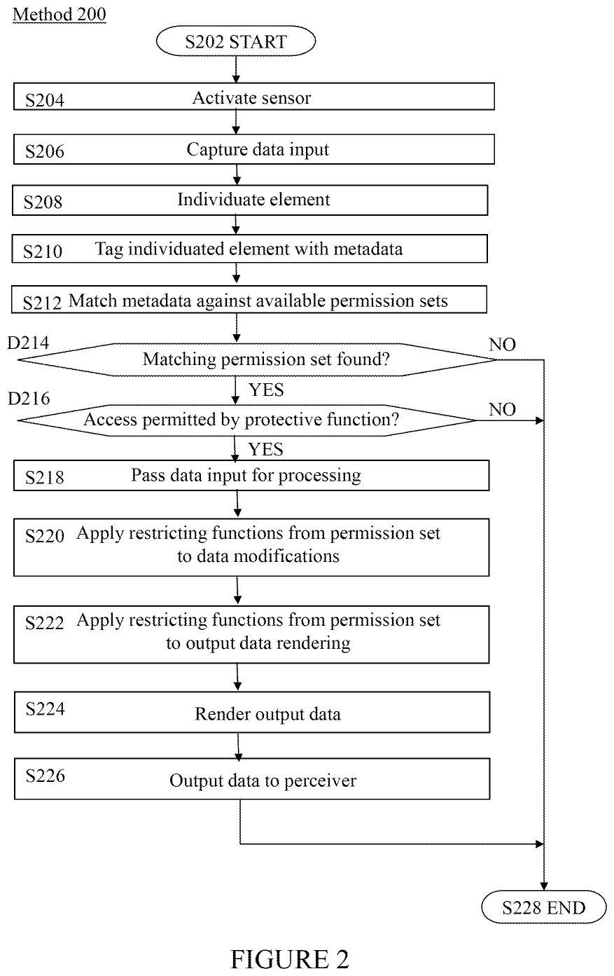

Referring to FIG. 2, a method (200) embodying the present technology will now be described.

The method starts at step S202.

At step S204, a sensor of a device, such as the sensor (106) of device (102), is activated.

At step S206, the sensor captures data input. The data input may represent data of an environment around and/or near the sensor. For example: where the sensor is a microphone, the data input may include ambient noise. Captured data input may be referred to as raw sensor data. The data input may be introduced to a data flow, such as a first stage (110) of data flow (108).

At step S208, one or more elements of the data input are individuated, such as by an individuator (112).

At step S210, the one or more individuated elements are tagged with identifying information, such as metadata. The one or more individuated elements may be so tagged by a metadata tagger, such as the metadata tagger (114) of device (102).

At step S212, the identifying information with which an individuated element is tagged is compared with one or more permission sets, such as permission sets (120) to aid in determining a correspondence, association, and/or match between the identifying information and permission data in the one or more permission sets, thereby determining whether and to what extent access, control, modification, or interaction between an application and the individuated element is permitted. The comparison may be performed by the matcher (118) of device (102).

At decision step D214, it is determined whether a matching permission set is found. If the outcome is negative, the process ends at end step S228. If the outcome is positive, the process continues.

At decision step D216, it is determined whether and/or to what extent access, control, modification, or interaction between an application and the individuated element is permitted based on the permission(s) identified by the match. If no access/control/modification/interaction is permitted, the process ends at end step S228. If access/control/modification/interaction is permitted, the process continues.

At step S218, the data input is passed for processing according to the matched permission(s). The data input may be passed for processing from a first stage (110) to a data in process stage (134) of data flow (108).

At step S220, one or more restricting functions are applied in response to a request to modify an individuated element in accordance with one or more matched permissions identified in step S212. One or more restricting functions may be so applied by a restricting function component (122).

At step S222, one or more restricting functions are applied in response to a request to render output data, such as output data at output data stage (136), from an individuated element in accordance with one or more matched permissions identified in step S212. One or more restricting functions may be so applied by the restricting function component (122).

At step S224, output data is rendered, such as by an output renderer (138).

At step S226, the rendered output data is output to a perceiver, such as perceiver (142). The perceiver may be a user of the device (102) on which the above method is performed. Examples of rendered output data may include: visual data, such as a photograph; audio data, such as an audio clip; audio-visual data, such as a video file; and augmented reality data, such as pass-through audio-visual data having additional or modified data superimposed thereon.

The process then ends at end step S228.

In an embodiment, the device may receive a request or prompt to use one or more application-specific restricting functions. The request or prompt may include the one or more application-specific restricting functions or a pointer to where the application-specific restricting functions may be obtained, such as via a URL to a server on which the application-specific restricting functions are stored. The request may originate from an application executing on the device, or it may originate from an external source (such as a content provider, for example a museum, a mall, or a conference center) and relayed by an application to the operating system.

In an embodiment, the device analyses the one or more application-specific restricting functions to determine whether any of the application-specific restricting functions are incompatible with one or more relevant permission sets. The device may include a specific analysis module configured to make such determinations.

The determination of incompatibility may include comparing the application-specific restricting functions to one or more of the aforementioned restricting functions, determining whether an application of an application-specific restricting function would result in a more or less restricted output data, and allowing or rejecting the request or prompt based on the determination. For example, if the request includes an application-specific restricting function which requires access to a child's face, and the device comprises a restricting function requiring any occurrences of a detected child's face to be blurred, then the request or prompt may be denied in whole, or at least in part. If the request includes an application-specific restricting function that controls the drawing of advertisements on identified billboards at the side of a road, and there is no restricting function that entirely restricts the drawing of an advertisement in those circumstances, the operating system may adopt the requested application-specific restricting function for application in a method of any aforementioned embodiment.

A request or prompt to use one or more application-specific restricting functions may originate from an external source. For example, if it is detected that a device has entered a museum, then a service operating on behalf of the museum, perhaps via a museum-specific application executable on the device, may send a request or prompt to the device to implement one or more application-specific restricting functions related to the museum. For instance, to display museum-related content on identified panels, to draw directional arrows, or to provide audio content on detecting viewing of certain displayed sculptures and/or paintings. The request or prompt may itself be prompted by a detection that the device has, for example, connected to the museum's Wi-Fi network, or that the device has entered a geofence defining the museum grounds.

As will be appreciated by one skilled in the art, the present techniques may be embodied as an apparatus, system, method, or computer program product. For example, the present techniques may be embodied in hardware logic incorporated into an augmented reality wearable apparatus, or may be embodied in a combination of wearable apparatus and a wired or wirelessly connected device, such as a mobile phone. In another instance, the techniques may be embodied in the form of a firmware or software logic arrangement, which may be stored or downloadable on a suitable apparatus.

Accordingly, the present techniques may take the form of an entirely hardware embodiment, an entirely software embodiment, or an embodiment combining software and hardware.

Furthermore, the present techniques may take the form of a computer program product embodied in a computer readable medium having computer readable program code embodied thereon. The computer readable medium may be a computer readable signal medium or a computer readable storage medium. The computer readable storage medium may be a non-transitory computer readable storage medium encoded with instructions that, when performed by a processing means, cause performance of the method described above. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object, or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods, or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In one alternative, an embodiment of the present techniques may be realized in the form of a computer implemented method of deploying a service comprising steps of deploying computer program code operable to, when deployed into a computer infrastructure or network and executed thereon, cause said computer system or network to perform all the steps of the method.

In a further alternative, the preferred embodiment of the present techniques may be realized in the form of a data carrier having functional data thereon, said functional data comprising functional computer data structures to, when loaded into a computer system or network and operated upon thereby, enable said computer system to perform all the steps of the method.

It will be clear to one skilled in the art that many improvements and modifications can be made to the foregoing exemplary embodiments without departing from the scope of the present techniques.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

What is claimed is:

1. A computer-implemented method of operating a device, comprising:
operating a sensor to capture a data input;
individuating an element of the data input;
tagging an individuated element with metadata;
matching the metadata with an associated permission set; and
applying a restricting function defined in the associated permission set to the individuated element during a process flow to produce augmented reality output data restricted as required by the associated permission set.

2. The computer-implemented method of claim 1, the restricting function comprising at least one of a security function, a privacy protection function, an access security function, a modification restriction function, and an obfuscation function.

3. The computer-implemented method of claim 1, comprising applying the restricting function when an application attempts to access the individuated element for processing.

4. The computer-implemented method of claim 3, wherein applying the restricting function when an application attempts to access the individuated element comprises applying an access security function.

5. The computer-implemented method of claim 1, comprising applying the restricting function in response to an application attempting to modify the individuated element during processing.

6. The computer-implemented method of claim 5, wherein applying the restricting function when an application attempts to modify the individuated element comprises restricting types of modification allowed.

7. The computer-implemented method of claim 1, comprising applying the restricting function when an application attempts to render the augmented reality output data.

8. The computer-implemented method of claim 7, wherein applying the restricting function when an application attempts to render the augmented reality output data comprises obscuring personally-identifiable information of the individuated element.

9. The computer-implemented method of claim 8, wherein obscuring personally-identifiable information of the individuated element comprises obscuring a personally-identifiable visual representation.

10. The computer-implemented method of claim 8, wherein obscuring personally-identifiable information of the individuated element comprises obscuring a personally-identifiable electromagnetic emission.

11. The computer-implemented method of claim 7, wherein applying the restricting function when an application attempts to render the augmented reality output data comprises blocking rendering of undesired distracting entities.

12. The computer-implemented method of claim 1, comprising receiving a request to implement at least one application-specific restricting function, determining whether an incompatibility between the at least one application-specific restricting function and a permission set exists, and implementing or rejecting the at least one application-specific restricting function based on an outcome of the determination.

13. A device, comprising:
a sensor;
an individuating component to individuate an element of sensor data from the sensor;
a tagging component to tag the individuated element;
a matching component to match a tag of the individuated element with a permission of a permission set; and
a restricting function component to restrict an application's interaction with the individuated element.

14. The device of claim 12, wherein the device is an augmented reality device.

15. The device of claim 12, comprising the permission set.

16. The device of claim 12, wherein the restricting function component comprises at least one of an input access control component; a data modification control component; and a data output rendering control component.

17. The device of claim 12, further comprising a model, and wherein the individuating component and tagging component are operable with the model to individuate and tag the individuated element.

18. The device of claim 17, wherein the model is an inference model trained on a data set of elements that have been tagged with identifying metadata.

19. The device of claim 17, wherein the model is an inference model developed using neural network techniques trained on a prepared and tagged dataset to provide a recognition of an element.

20. The device of claim 13, wherein the permission set comprises a data structure which associates permission data with the tag applied to the individuated element by the tagging component and with an application installed on, installable on, or executable on the device.

21. The device of claim 13, wherein at least one sensor comprises a camera.
